(19) United States
(12) Patent Application Publication
(10) Pub. No.: US 2002/0167939 A1
(43) Pub. Date: Nov. 14, 2002

(54) Wireless data input engine

(76) Inventors: Deborah Weissman-Berman, North Fort Myers, FL (US); Chuen W. Louie, Bayside, NY (US)

Correspondence Address: Daniel S. Polley, Esq., Malin, Haley & DiMaggio, P.A., 1936 South Andrews Avenue, Fort Lauderdale, FL, 33316, US

(21) Appl. No.: 10/012,223

(22) Filed: Oct. 30, 2001

Related U.S. Application Data
(60) Provisional application No. 60/244,863, filed on Nov. 1, 2000.

(51) Int. Cl. H04L 12/28

(52) U.S. Cl. 370/352; 370/351

(57) ABSTRACT

A relatively very fast and scalable algorithm, preferably in the form of software residing on a server, is provided for transmitting data in the form of equations or database input to and from small palm OS, pocket PCs, handheld PCs, web enabled phones or convergence devices such as web enabled phones with complete PDA systems built into the phone. The server based algorithm is efficient precisely because it minimizes information through put to and from the PDA. An integral part of the server is a “front end” page, referred to as WDIE feather, where the page is carefully derived not on the basis of “content” but on the basis of “context” which provides the minimum and necessary information to the user.

This application claims priority to and the benefit of U.S. application Ser. No. 60/244,863, filed Nov. 1, 2000.

### BACKGROUND OF THE INVENTION

1. Field of the Invention

This invention relates generally to long-distance, together with LAN and short distance, wireless Internet access and particularly to a wireless data input engine that allows faster throughput for higher speed, wireless access to the Internet via the use of modularized data processing techniques.

2. Description of the Prior Art

Like the emergence of the Internet in the 1990's, wireless Internet technology has exploded onto the scene at the dawning of the 21^{st} century. The vast amount of information available on the World Wide Web can now be brought to mobile handheld wireless devices such as cellular phones, Pocket PCs, Palm and other PDAs, which have an internal browser.

However, inherent in current long-distance wireless internet communications, are relatively slow access times, due to the low speed modem or transmission connections of most wireless internet systems. During the loading of a Web page at 19.2 kbps, the common rate of cellular phone modem connections, many hand-held computers simply “freeze up” or take such a long time to download the page that by the time the page is displayed, the need for the information no longer exists.

Certain Web pages request identification and other input parameters from the user. The user enters these values and they are sent to the server, where complex algorithms, stored on the server, provide a solution or answer, based upon the user's input values. This answer could be in the form of alphanumeric data, text, audio, graphics, streaming video, or the combination of all. Due to the technological constraints of the user's hand-held computer, and the wireless modem connection, the user must wait an interminable amount of time or be dropped off-line, before receiving the derived answer.

Further, many Web pages take a long time to load due to their complex HTML coding. If the user requires an answer to his or her query immediately, there is no need to view the superfluous information contained on the page.

Although the public is always clamoring for more speed, many computer users are quickly realizing that waiting for your computer to access a site is becoming the norm. However, the need for providing quick answers to user inquiries, in a mobile, wireless environment is critical, including, but not limited to, engineering, military, business enterprise solutions and the medical field.

This can best be illustrated in the medical and financial industries. In the medical field, for example, paramedics may arrive at an accident scene and realize that the scenario presented to them requires immediate access to medical procedure records stored at a remote medical facility database. Via a hand-held PDA, the paramedic may enter input parameters, such as the victim's injuries, and request text, audio or even video guidance on how to best perform a particular medical procedure. The paramedic requires only this information and has no need for any extraneous information. He or she needs accurate answers quickly. Obviously, in this scenario, any Web page transmission delays could prove devastating, if not fatal.

To a lesser degree, mobile users may need up-to-date financial records, and once again, only certain information that is requested by the user is needed. Complex Web pages containing additional, non-essential information would slow down the transaction, and by the time the answer is provided to the user's query, the information may be useless, due to the time delay in providing it, or the difficulty in browsing a full PC display of Internet content and the likelihood of not seeing important information.

Unlike browsers for mobile devices such as AvantGo™, which allows users to interact with a reduced data set on the internet, the present invention applies only to individual applications where the interface is provided by the server to the device, and all operating code or data information pages reside on the server. Because the present invention is not a web-clipping browser, only user-necessary content which does not slow down user-server transactions is transmitted.

What is therefore needed is a user-server interface architecture scheme that allows mobile users of hand-held wireless devices such as Palm or Pocket PC PDAs using a wireless connection or a cellular phone as a modem, to access the World Wide Web and obtain basic information, in response to their input parameters, at speeds a user normally associates with conventional hard-wired modem connections.

It is therefore, to the effective resolution of the aforementioned problems and shortcomings of the prior art that the present invention is directed.

### SUMMARY OF THE INVENTION

The present invention is a vertical or horizontal market conduit application that allows users of wireless devices to obtain high-speed Internet throughput and to enhance individual Web site capabilities.

The invention provides a universal means of intercommunication among many types of communication services, from wireless browsers to wired servers. It provides an interface and service interpolation scheme that bridges communications between devices and the server. The framework for the intercommunication is server based.

Generally, the invention applies to any wireless user-server scenario where the mobile user possesses a cell phone with a WAP or other-enabled browser, a PDA, or other hand-held mobile computing device.

The invention can consist of two parts, the server algorithm (WDIE™) and a Data Matrix Page referred to throughout the application as “WDIE feather” on which is defined input and output data for mobile PDA devices. Each feather is either an input or an output page defined for viewing on the small screens of PDA devices. WDIE feather can consist of two kinds of generic pages, an Equation page and/or a Data Matrix Page.

WDIE feather—Definition: A page defined Equation or Data Matrix input optimized for long-distance wireless transmission, from any PDA having an internal browser. The page can be delimited on and transmitted by a server or alternatively modified on a PDA.

A feather page is designed to be read by a browser and is not limited to a specific PDA operating system (OS). WDIE feather is not dependent on software written specifically for a PDA operating system residing in part or in whole on that PDA. Therefore the present invention is not limited to any specific current or future PDA operating system. Each page is transmitted from the server to the PDA. The user then inputs the relevant data for the application. The page is then transmitted wirelessly back to the server as discrete input (by itself) and updated on the server.

Unlike other current Application Developments for PDA's, the WDIE server based algorithm uploads data input and downloads data output, rather than downloading applications that would have to be written for a specific OS and also take up a lot of the available memory on that device. The application and processing of the data input occurs at the WDIE server. WDIE feather is not a portal, rather it is a page which can contain entered data, equations, etc. WDIE itself is a server based algorithm interface to long-distance wireless devices. WDIE feather is preferably a discrete download page oriented data input/output matrix. The page is preferably ‘optimized’ for the small screen of a handheld or PDA device to provide the maximum READABLE data ‘context’, instead of the maximum ‘content’ found on larger PC displays connected to the Internet. In conventional usage, ‘content’ generally implies displaying the maximum amount of connected, overlapped or separate information (together with links to further information) on any one displayed web page. However, in the present invention application, ‘context’ will be defined as only the relevant data displayed that is needed for the task to be performed in a short time-frame. WDIE feather deploys defined mobile Equation applications and solutions and/or WDIE Data Matrix pages for applications using the power of transmitted data and/or matrix entry forms to the server. Therefore WDIE is a unified delivery of presence data back all the way to the server, or system server integrated with a host system.

In the case of a system server integrated with a host system, WDIE™ together with WDIE feather may be defined as a ‘middleware’ solution for integrating enterprise handheld resources with ‘legacy’ stand-alone or network solutions. WDIE™ offers wireless connectivity to database and other information resources residing on a single server or a network. The present invention makes the task of entering, transferring and updating data in real time possible for long-distance wireless connections.

### WDIE Feather Page

1) For each Equation page, the input and output pages are discrete. That is, the input is entered by the user for each page displayed on the screen, it is processed at the server and returned by the server to the wireless mobile device as a stand-alone output page. There is a defined input, and a calculation algorithm based on the server yields the output on the output page.

2) For the Data Matrix Page, the original input is discrete on the data page, and may consist of alpha and numeric input. If the data is to be calculated, then a code is written to represent the equation. In this case, the output looks like the output page for the equations. The output can be the same data (sent back to the user for verification), index-keyed data or updated data, via mathematical calculation, spreadsheet analysis or updated relational database.

### WDIE Feather Page Matrix

1) WDIE feather Page Matrix is a front-end delivery mechanism for server based Web services.

2) The Data Matrix is effectively partitioned into pages at the server for delivery to the PDA. The basic unit of input/output is the Page.

3) Pages can be joined via index-keying to form a large database. Index keying is the built in function of WDIE design via usages of the User Session ID and the matrix nodes settings. The WDIE interface with preferably SQL servers in the server side to create access pointer to the server side data pages (include text, photo, video & audio) or Input/Output pages for the Equation pages.

4) An expanded page assembly scheme resembling the organization of a mathematical matrix may also be used both to assemble a large matrix from pages and to form a grid overlay on an existing enterprise database to facilitate decompartmentalizing the existing data into WDIE feather pages. The data pages (and data contained in each page) can be assembled, reassembled (or operated on) as long as the nodes of each page, and adjoining pages, are keyed in a process referred to herein as index-keying. In this way, the total number of matrix pages is scalable.

5) If a square matrix is employed, the following conditions may be necessary for segmenting a database organized like a mathematical matrix:

a. Nodes, known as page delimiters, are index keyed;

b. Data pages are joined to form square matrices;

c. Square matrices are matrix data pages composed of REAL data;

d. A square matrix is the same as its transpose (called an Hermitian matrix). Thus, pages can be reassembled at the nodes no matter how the indices are keyed—which maintains the continuity of index keyed nodes across individual pages;

e. Since matrices of the same order( i.e. a square 2×2 matrix) can be added, subtracted, multiplied or raised to a power of itself, the matrix preferably remain square to facilitate data manipulation, page by page.

The ability to create peer computing by moving page delimited server or PC based information to/from a small mobile wireless device quickly over a long-distance wireless connection is necessary to facilitate the increasingly distributed nature of a corporate workforce.

The server provides the user with a table, a form which can be enhanced by graphics, or some other form of data-entry means, the user enters input parameters which are transmitted back to the server for processing, and a solution is sent back to the user where it is viewed on the user's computer screen.

The invention can also provide a means for detecting a user's connection speed and for transmitting code to the user, preferably Java or a standard equivalent parsed down to modules of sufficient size, preferably, though not limited to, less than or equal to approximately 2 k bytes at a time, so that he or she may download all of the information necessary to provide the input parameters. Module by module is sent, received, and processed by the server which can be line-by-line, for Java code.

The server can include a Server Manager which, based upon the user's connection speed, scales the Java code, and returns a Dynamic HTML page to the user, including the solution based upon the user's data entries as well as additional tables, or forms, should the user wish to continue data entry. In summary, WDIE built in functions also include the interface with current commercial servers or home or other application servers. These include (1) application server for processing native applications; (2) java based application server for processing java applications; (3) media stream servers for handling video and audio in stream format; (4) SQL servers for database access; and (5) display servers for handling photos and graphs.

The WDIE algorithm is preferably provided in the form of software residing on a server, and is preferably written in java code. Java is selected for the server so that pages received from WDIE™ can be returned via a dynamic HTML page to any browser residing on any operating system. WDIE feather is front end (for input) and back end (for output) to WDIE. The WDIE feather pages also reside on the server. The application the invention is used for will determine the language the specific WDIE feather pages are written in (i.e. C++, Java, etc.).

Accordingly, it is an object of the present invention to provide a data input engine that provides users of wireless devices with higher speed internet access to Web page information given the technological constraints of wireless modem connections.

It is yet another object of the invention to allow multiple users, via wireless modem connections, to present input parameters and obtain quick, on-line solutions to mathematical problems or data page input based upon the input parameters with no specific CPU dependencies.

It is still another object of the invention to provide a wireless user-server system that allows the server to handle thousands of user inquiries by means of transmitting only necessary modules of code to each user.

In accordance with these and other objects which will become apparent hereinafter, the instant invention will now be described with particular reference to the accompanying drawings.

### BRIEF DESCRIPTION OF THE DRAWINGS

FIG. 1 illustrates the applications of the present invention by depicting the interface between the data input engine of the present invention and various end users.

FIG. 2 illustrates a flowchart of the method of the present invention.

FIG. 2(a) illustrates an expanded flowchart for WDIE feather.

FIG. 2(b) illustrates the organization of Equation Pages and Data Matrix Pages for WDIE feather.

FIG. 2 (c) illustrates a connected “grid” of WDIE feather pages.

FIG. 3 illustrates a logical flow diagram of the application server interface of the present invention.

FIGS. 4-11 illustrate sample Web pages allowing the user to access the data input engine of the present invention and to provide the necessary input parameters, with FIG. 4(a) illustrating the full wireless interface page.

FIG. 12 illustrates a sample personnel page which can be used with the WDIE feather data matrix.

### DESCRIPTION OF THE PREFERRED EMBODIMENTS

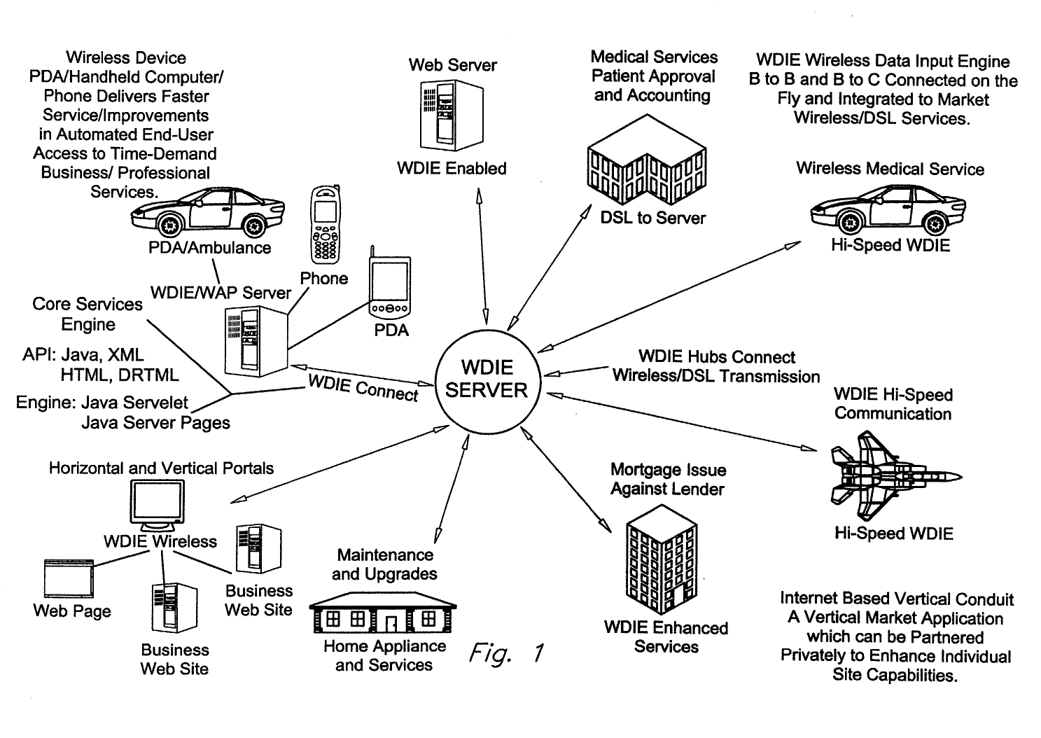

Referring to FIG. 1, the system and method of the present invention are shown. The invention is a Wireless Data Input Engine (“WDIE”) 100 that serves as a gateway for wireless users to access the Internet.

FIG. 1 illustrates a wireless internet network architecture of the present invention wherein a multitude of wireless device users can access various sites and databases via one data input engine 100. WDIE™ 100 improves end-user access to time demand business and professional services.

The data base input engine of the present invention can be utilized with handheld, Palm, pocket PDAs, and web-enabled phones, utilizing, but not limited to, a .PRC Browser and .PQA coding for a Palm OS although is equally applicable to any Pocket PC or hand-held computer utilizing a wireless modem connection and all are considered within the scope of the invention.

The design of the present invention can be based upon multi-threaded Multi-Scaleable Java Servelets and JavaServer Pages. The connection speed of the user can be first detected. The server is designed to support dynamic help or new 3D graphics. Upon access to the desired Web site, the user's PDA or phone device displays compact HTML pages including data input tables or forms in order to receive input user parameters. A key feature of the invention is that the size of the tables or forms presented on the user display is minimized in order to display them with maximum speed. The software employed can be full JAVA code. The JAVA coding is processed line by line. The coding is broken down into minimal sections. Each module of code is downloaded, with enough code to present the user with the required tables, forms and photographs/graphics for the required data parameter entry. The code modules can be preferably limited to approximately 2 k bytes but less than approximately 55 k per page of download, though such is not considered limiting.

Downloads are kept as small as possible. Because no processing occurs at the PDA/phone (user) end, transaction time is minimized. Care must be taken by the Process Manager at the server end to provide sufficient coding to account for user input changes, which would, in turn, produce different parameters. Therefore, one module, or section of code at a time is sent, received, and processed at the server end. This is the technique of scaleable coding and in this manner, the server can handle thousands of user inquiries.

In addition to text, eye-catching visual graphics, or “Eye Candy” can be provided to the user. As the FCC allocates increased bandwidth capabilities, additional features, such as streaming video, can also be provided, again preferably utilizing modularized, or scaleable coding.

The server preprocesses user entry values to remove roundtrip-checking time. The parameters are sent to a Java App Server Manager, which is used for scaling and to support both an expanding user base and new applications. The server processes and returns the results via dynamic HTML pages. All algorithms used for processing are stored at the server. A new form can be added to the dynamic HTML page for continuing data or process entry. The processing loop continues in this fashion.

Because WDIE™ is not a browser and is not stored on the user's computer, the processing of the computational algorithms are not based upon any CPU dependencies. In other words, code can be freely distributed and made available to all types of users, regardless of their CPU capabilities.

The present invention includes a user-to-server front-end interface design based upon modularized data input and modularized data processing. For desktop, laptop/notebook, handheld and PDA computers, the input is presented via HTML input tables or forms. Each form is displayed as a whole and can be scrolled by the device browser. Input is tabulated line by line. When the form is complete, the device “pings” wirelessly to the server.

At the server, a number of security requirements essential to opening widespread wireless data transmissions can be implemented, including firewall negotiation and server based security with solid support for finger imaging biometric data and other conventional security techniques, which is confirmed when the user access is processed.

The server processes the user's input data and returns a dynamic HTML page. Specialized vertical and horizontal market corporate or Government software can also be processed on the WDIE™ server, where input/output is directed to a third party Web or in-house server. The input enters the specified channel the output is received at the WDIE™ server—the point of contact (POC wireless device) is “pinged”.

The Wireless Data Input Engine of the present invention, by utilizing a front-end inter-access code can be used with pocket PCs and handheld PC devices and can be adapted for use with PALM and all PALM-type or Pocket PC OS PDA's and WAP or other-enabled phones.

Preferably, all of the information used by WDIE™ is on the server. However, each PC, handheld PC, PDA or phone browser will interpret the content differently and present the results on the screen of the mobile device. For example, a typical Palm PDA browser will read the text only. Therefore, the photos, frame-lines and all other “eye candy” apart from the text will be omitted from that presentation of WDIE ™ on that device. Thus, preferably all pertinent user information for WDIE feather pages is written on the smallest PALM PDA screens, and on large PC screens. The information downloaded to a Pocket PC is preferably formatted to fit that screen by the browser. In this manner, the execution of each WDIE feather page preferably has the correct context on the screen for that device.

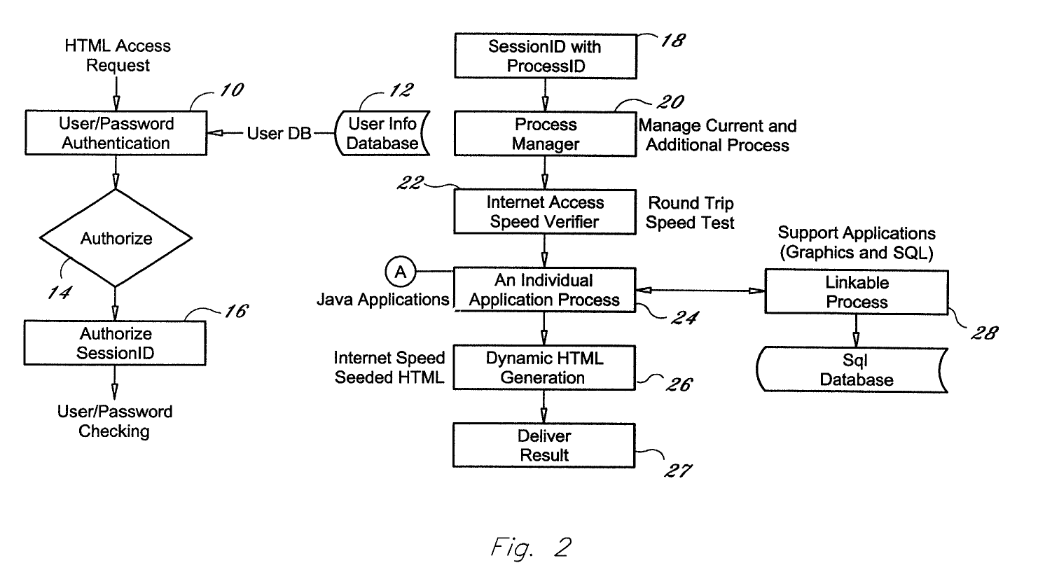

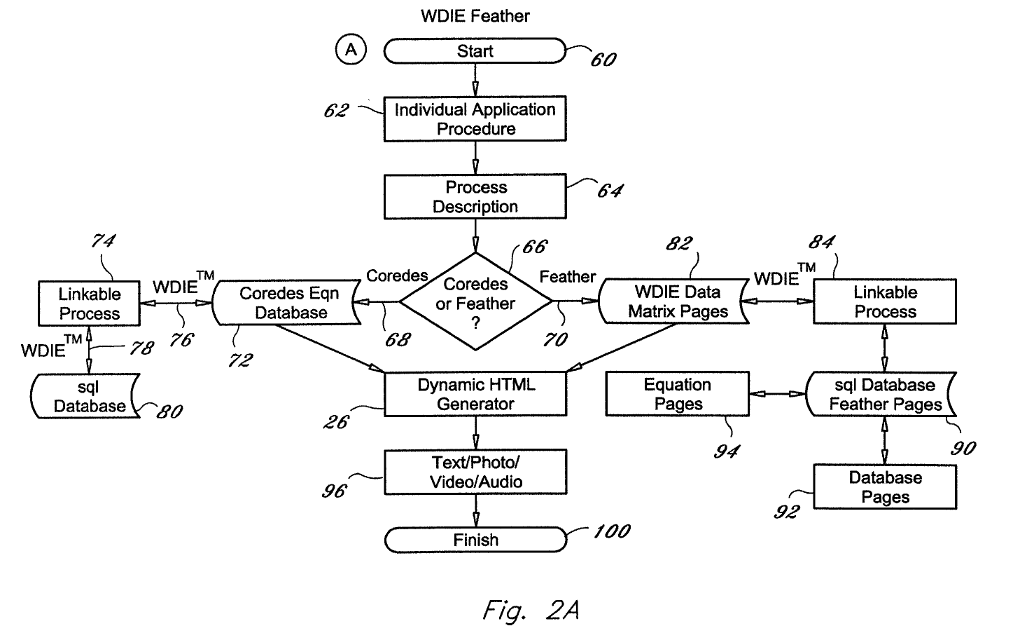

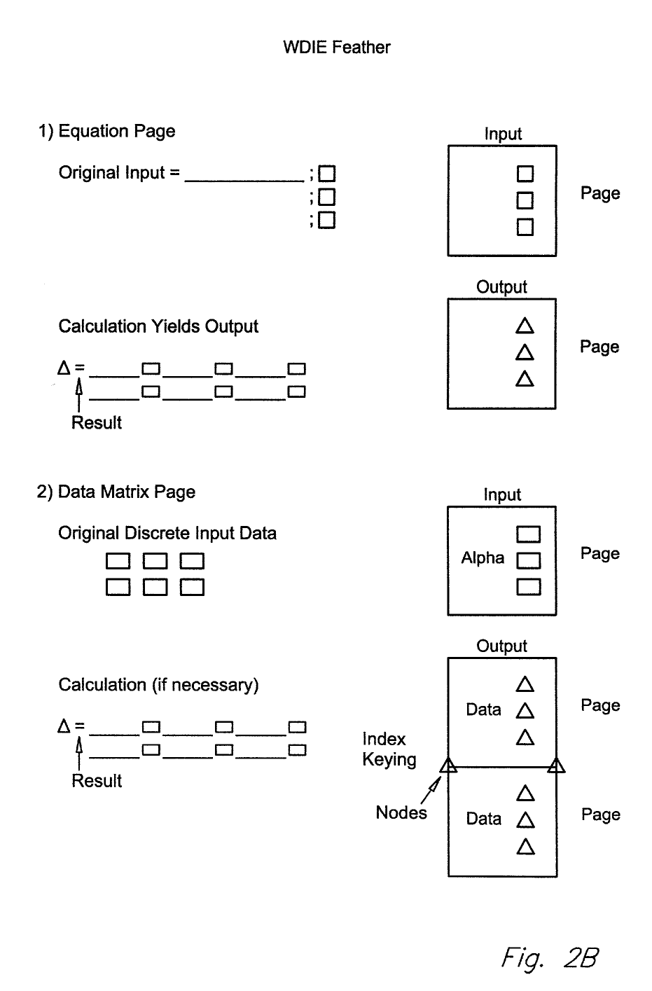

FIG. 2 depicts a flowchart illustrating the process taken by the data input engine of the present invention. When a user attempts to access the Web site, a verification process preferably first takes place. The User/Password authentication module 10 checks against an SQL User database 12. If there is a match, the module will create a session ID to allow the user access to the services provided by WDIE™ as shown by steps 14-16 .

The SessionID with ProcessID module 18 is comprised of static HTML pages and forms served from the server to users and receives the user input entries.

The Process Manager module 20 written in Java code checks entries and manages and executes each of the application services.

The Internet Access Speed Verifier 22 checks the user access speed and sets a scale for the result. While the industry standard practice is to merely display the user line speed or to create the same size result, the present invention determines user connection speed in order to provide scaleable modules of Java coding.

Modules 24-28 break down the code into small java classes to support each of the application services.

FIG. 2(a) illustrates an expanded flowchart for WDIE feather consisting of steps 60 through 100. This flowchart provides a detailed analysis of the steps involved for step 24 of FIG. 2. The process preferably starts with individual application procedure step 62. At this step an introductory explanation is provided as to what applications are generally available. At step 64, process descriptions are provided and describe what might be chosen by the user (i.e. COREDES—mathematical equations; relational database information or spreadsheet—WDIE feather, etc.) At step 66 the user then chooses a mathematical procedure, i.e. COREDES™ (branch 68), or a WDIE feather page (branch 70).

For COREDES™ 68, the procedure (COREDES Equation Database 72) is linked to an SQL database 80 through links 76 and 78 and linkable process 74. The equations are stored in database 72 (which can be written in java code or any other code as required) for calculating the output based on the user's input. SQL database 80 can be a commercial database and is where the output is assembled. To calculate an output, SQL database receives the input information (data) from a user's PDA or other wireless mobile device and the required equation from database 72. Database 80 then organizes the input information, runs the information through the relevant equation stored in database 72, and creates an output file of the result, which may also include other text and/or photos. The output file is then sent through WDIE™ back to the user and displayed on the user's PDA or other wireless mobile device. Once the output is calculated, the system then proceeds to HTML generation 26 for text, photo, video and audio, as shown. This step generates HTML code so the user's browser can read the output page.

Similarly, a WDIE Data Matrix Page 82 is linked to an SQL relational database 90 through WDIE lines 86 and 88 and linkable process 84, for either Equation or Database pages 94 and 92, respectively. Again once the output page has been created, the system proceeds to html generation 26 for text, photo, video and audio, as shown, so that the output can be read by the user's browser.

At step 96 all necessary text, photos, video and audio (which can be in communication with media stream and display servers) are combined. Any required photo, video or audio can be tagged to each line item of input, output or descriptive process. The output results are delivered at step 100, which is the equivalent of step 27 of FIG. 2.

FIG. 2(b) illustrates the comparative flow of input/output data to WDIE feather pages. In the Equation Page, the input is usually numeric and stored in a variable, □. The calculation, Δ, yields the output of the mathematical equation for the input, □. Each page can be formatted for a PDA, and the input/output optimized for the fastest long-distance wireless transmission speed. The Data Matrix Page is shown having original discrete (separate) input data, □. The input page can have alphabetic, as well as, numeric input. A calculation may be performed, as necessary, as for the Equation Page. The output can be the result of a calculation, the same data sent back to the PDA for verification on the data from a spreadsheet or updated relational database. Each page can be formatted for a PDA, and the input/output optimized for the fastest long distance wireless transmission speed.

FIG. 2(c) illustrates a connected “grid” of WDIE feather pages. In this case, a square matrix (i.e. equal number of columns and rows) of WDIE feather pages is shown. The “grid” may be placed over an existing spreadsheet or database page to reduce the original data to palm or other PDA WDIE feather page input.

As seen in FIG. 2(c), a connected “grid” of WDIE feather pages is created and placed over an existing spreadsheet or database page. This “grid” preferably becomes an interface to an SQL (relational) database. The index keyed nodes point to a WDIE data page and is linked to an output. For long-distance wireless transmission to small mobile devices, the text can be preferably limited to 2 k ranges for use on a Palm PDA or other small devices. However, such text size is not limited to 2 k, and other smaller and larger sizes can be used and are considered within the scope of the invention.

A symmetrical square matrix may be employed for some applications. The choice to use this type of matrix can depend on the organization of the original data. As an example, the “grid” shown in FIG. 2(c) preferably consists of a square matrix composed of WDIE feather pages placed over an existing database page to reduce the original data to WDIE feather Palm page size input. In this example, each four page segment forms a square matrix within which data can be manipulated.

Any page in the four page matrix, or any whole square four page matrix, can be reinserted via index keying, into the original database to update the original data.

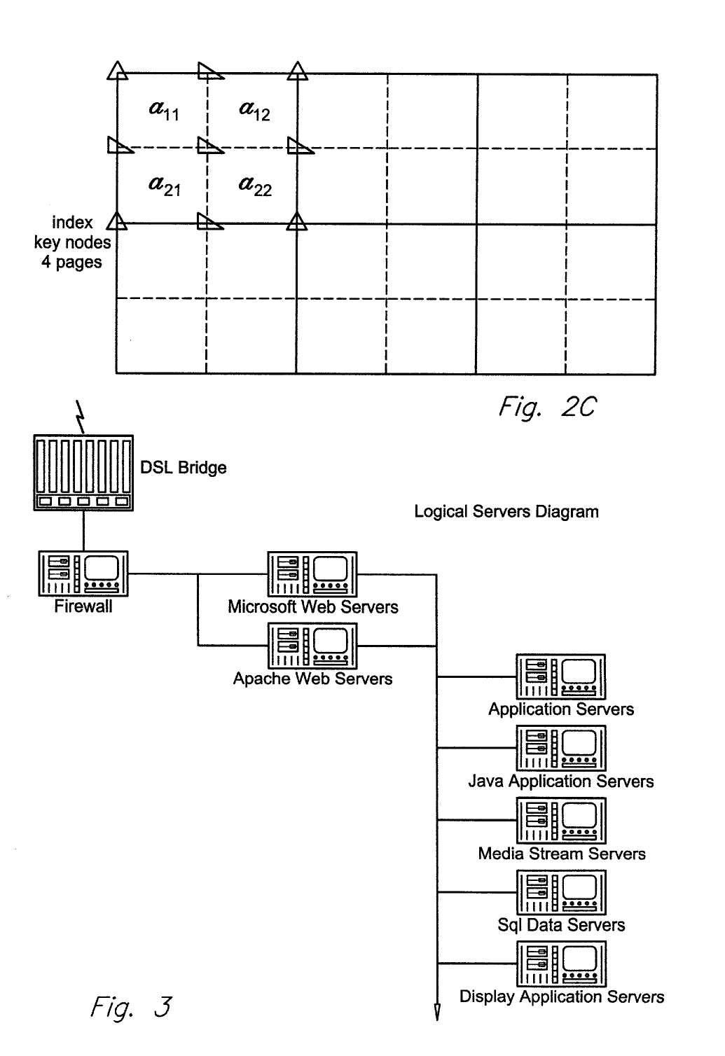

FIG. 3 illustrates a logical flow diagram of the application server interface of the present invention.

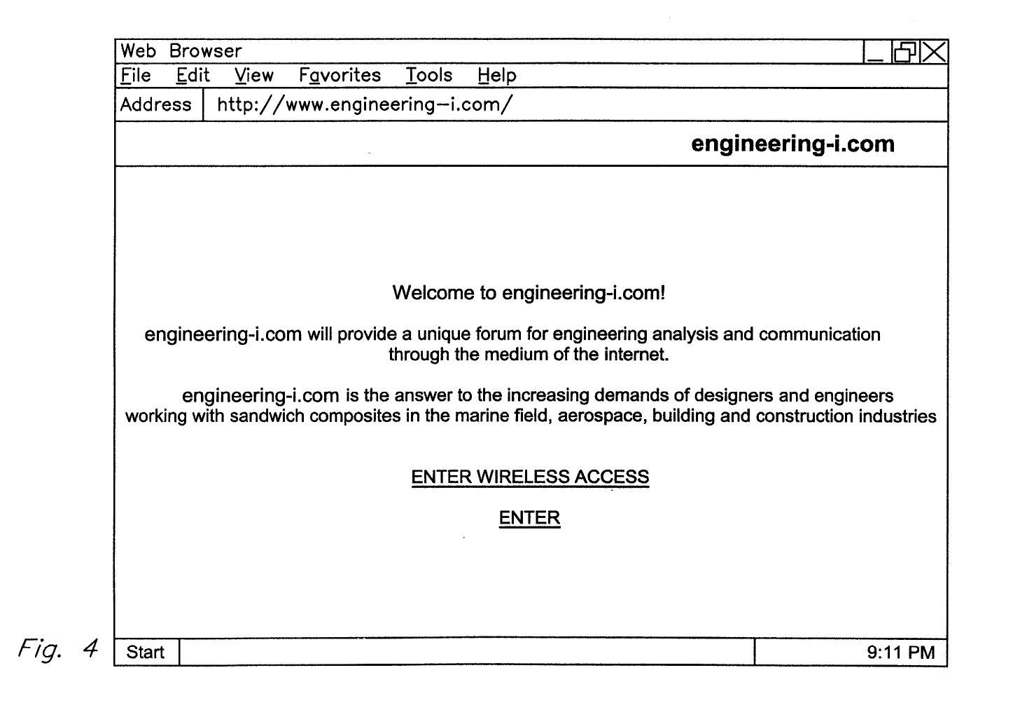

FIGS. 4-11 provide example snapshots of a typical Web site employing the WDIE™ of the present invention, running on a notebook computer, a handheld and a Palm OS PDA by Handspring, though the invention is not limited to these devices.

FIG. 4a allows the user to access WDIE™ 100 directly from the home page.

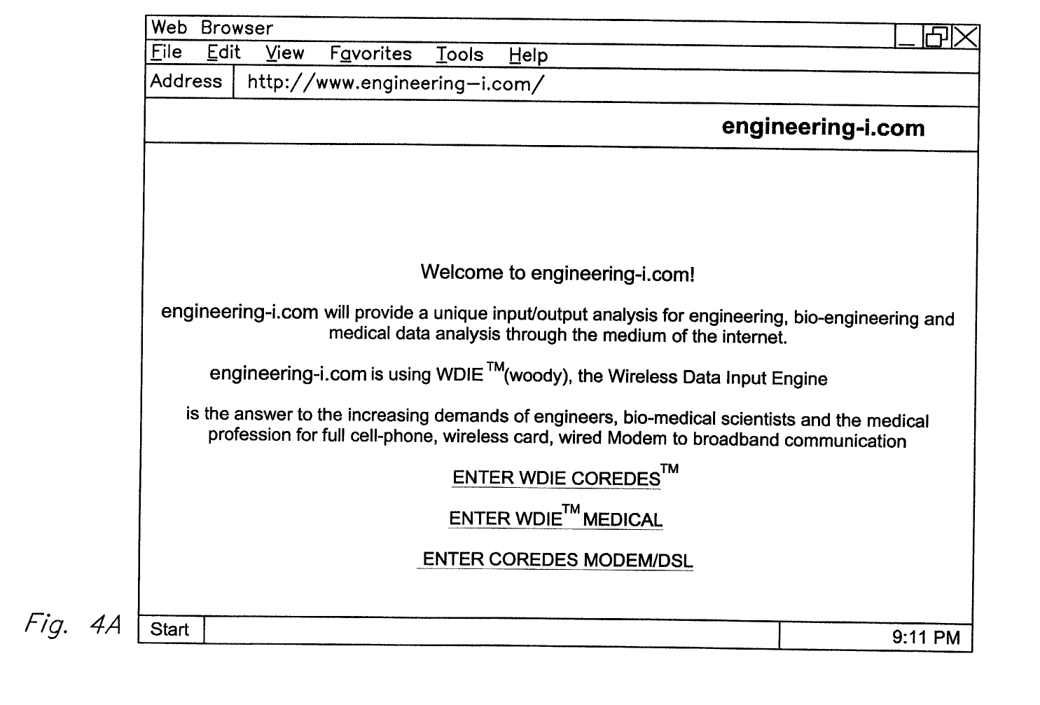

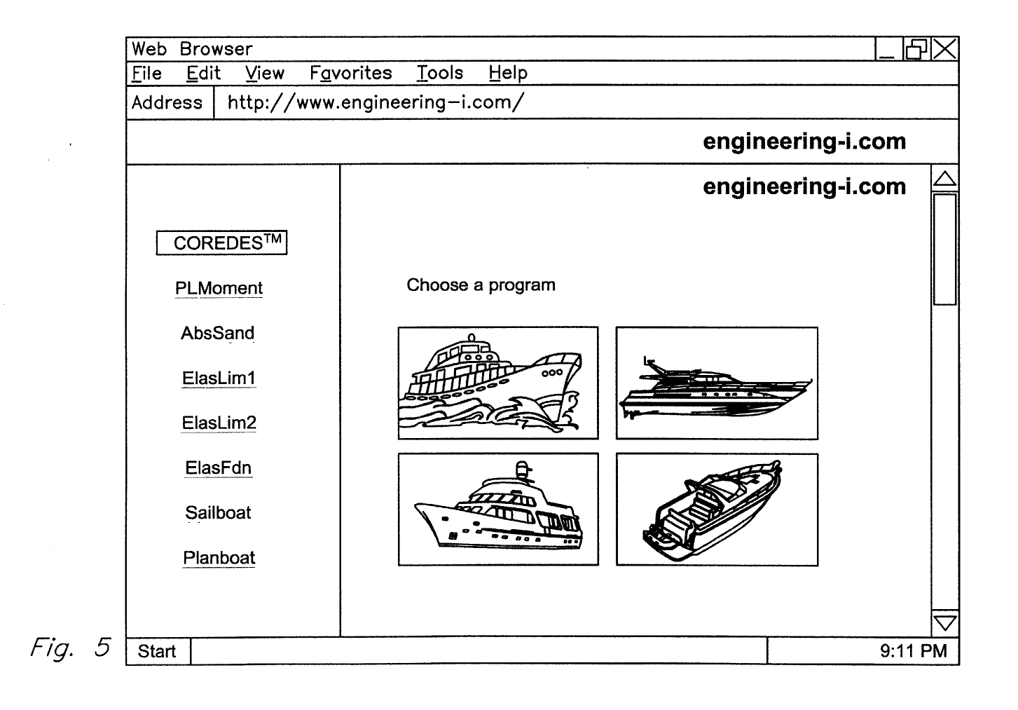

FIG. 5 provides a sample of the photographs and menu that can be sent to the user via WDIE™. Although the standard Web page displays additional features than what is displayed in FIG. 5, all of the information that is necessary for the user to provide input data, has been provided.

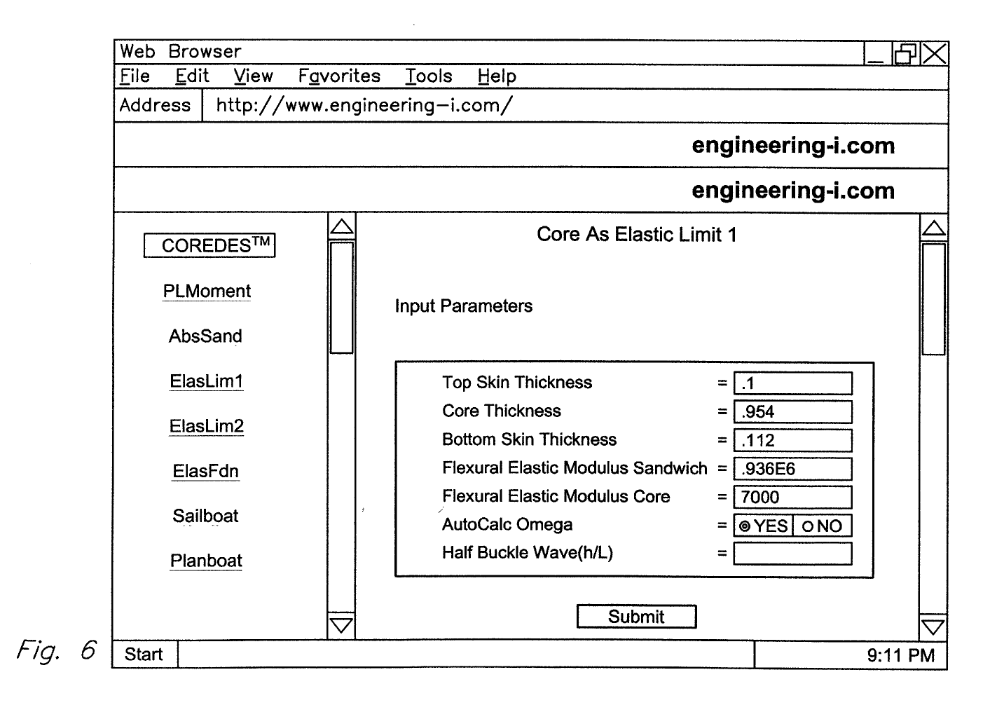

FIG. 6 displays the input table after a choice has been selected by the user from the input menu. The user can now provide the input parameters that will be forwarded to the server where the algorithms used to derive the mathematical solution are stored.

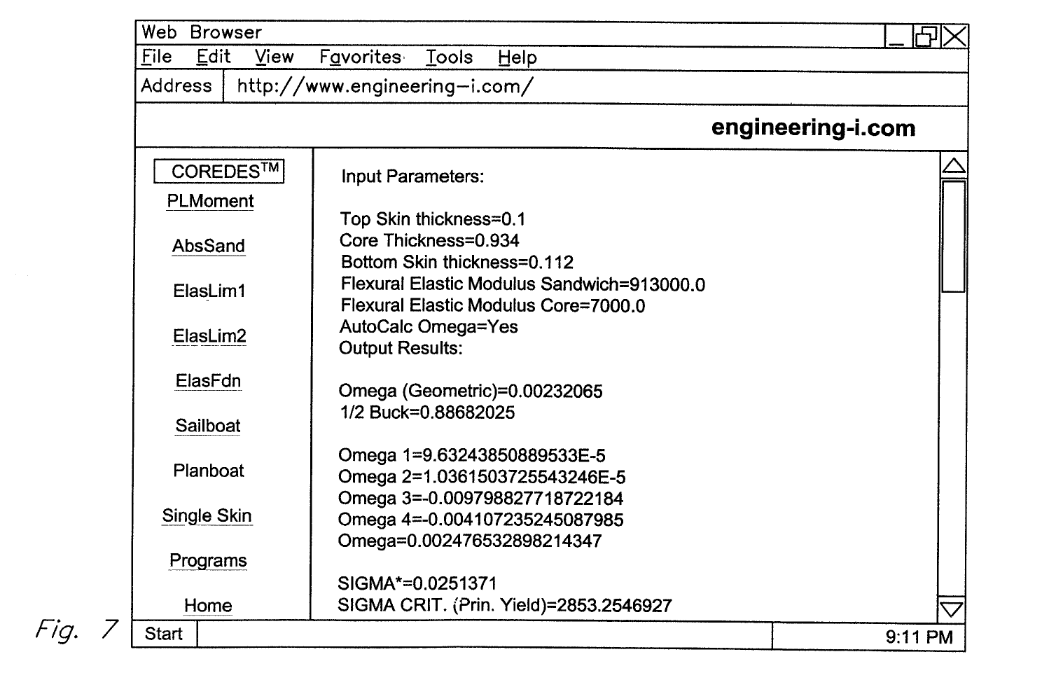

FIG. 7 illustrates the resulting solution appearing on the user's viewing screen. Once again, this display illustrates the result of a wireless transaction utilizing the present invention. Without the use of WDIE™ 100, the resulting solution cannot be obtained, nor would the hand-held computing device even be able to transmit many input parameters to the server at a minimum of 19.2 kbps to approximately 42-46 kbps modem connection, utilizing a PDA/cell phone or other similar computing device.

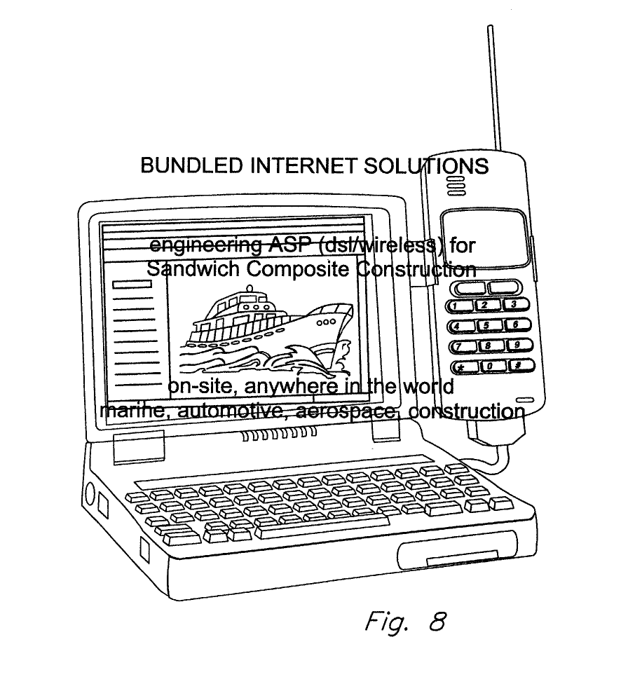

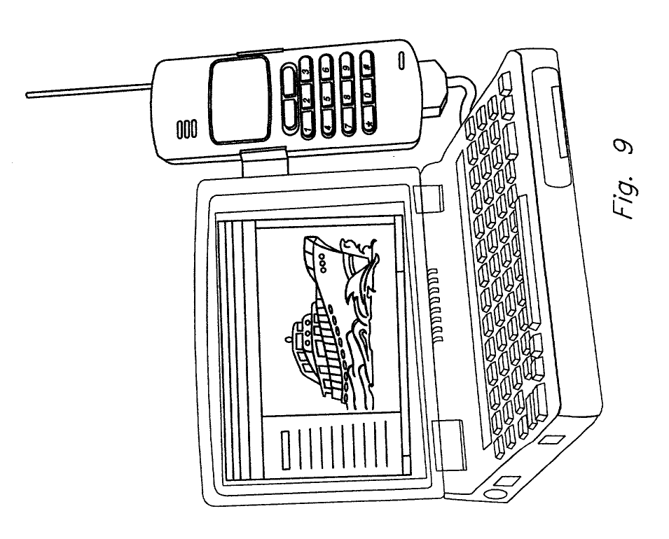

FIGS. 8-9 illustrate WDIE™ running on a handheld device.

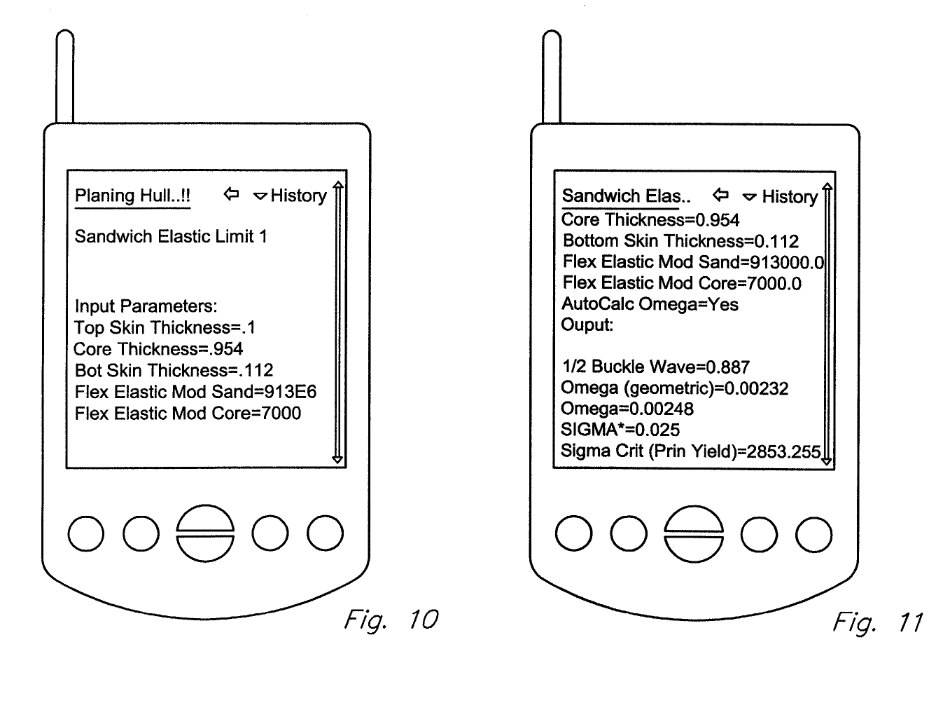

FIGS. 10-11 illustrate different menu selections and the tables presented to the user for receiving the input parameters and subsequent output on a Palm OS PDA.

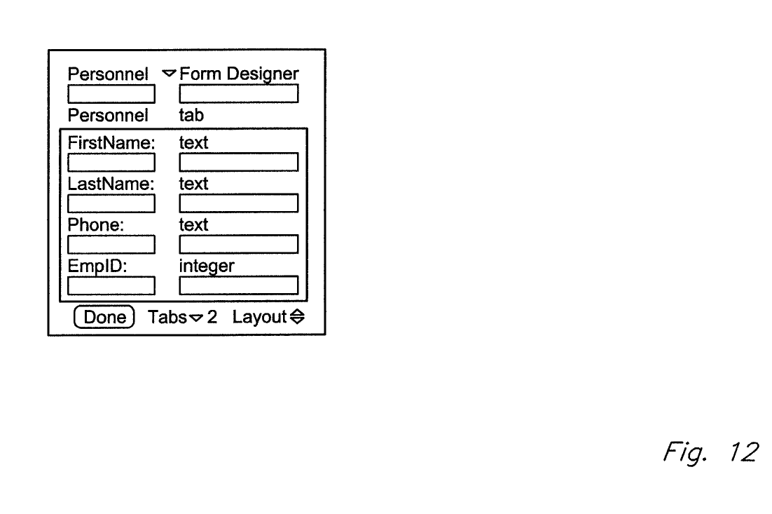

FIG. 12 illustrates a WDIE™ feather data page on a PDA, in this case for personnel management, though such is not limiting.

The instant invention is not limited to any one type of engineering design. The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A method for providing relatively faster throughput for higher speed, wireless Internet access for a mobile device, said method comprising the steps of:
(a) displaying an input page transmitted from a remote server on a screen of a wireless mobile device;
(b) wirelessly transmitting input data entered on the input page to the remote server;
(c) processing the transmitted data at the remote server; and
(d) displaying an output page on the screen of the wireless mobile device based on the transmitted input data.

2. The method for providing relatively faster throughput of claim 1 wherein step (c) comprises the step of running the inputted data through one or more equations stored within a database and creating an output file of the result.

3. The method for providing relatively faster throughput of claim 1 further comprising the step of formatting the output page to fit the screen of the wireless mobile device.

4. The method for providing relatively faster throughput of claim 1 further comprising the step of generating HTML code for the output page prior to step (d).

5. The method for providing relatively faster throughput of claim 2 wherein said output file further including additional text and/or photos.

6. A computer implemented process for calculating a result and displaying the result on a wireless mobile device, said computer implemented process comprising the steps of:
(a) displaying a discrete input page transmitted from a remote server to a screen of a wireless mobile device;
(b) entering input data by a user on the input page;
(c) wirelessly transmitting the entered input data to the remote server;
(d) processing the transmitted data at the remote server;
(e) creating a discrete output page at the remote server based on the user entered input data; and
(f) returning the output page by the remote server for displaying on the screen of the wireless mobile device.

7. The computer implemented process of claim 6 wherein steps (d) and (e) comprise the step of running the inputted data through one or more equations stored within a database and creating an output file of the result.

8. The computer implemented process of claim 6 further comprising the step of formatting the output page to fit the screen of the wireless mobile device.

9. The computer implemented process of claim 6 further comprising the step of generating HTML code for the output page prior to step (f).

10. A computer implemented process for calculating a result and displaying the result on a wireless mobile device, said computer implemented process comprising the steps of:
(a) displaying a discrete input page transmitted from a remote server to a screen of a wireless mobile device;
(b) entering input data by a user on the input page;
(c) wirelessly transmitting the entered input data to the remote server;
(d) processing the transmitted data at the remote server;
(e) creating a discrete output page at the remote server based on the user entered input data;
(f) returning the output page by the remote server for displaying on the screen of the wireless mobile device; and
(g) formatting the output page to fit the screen of the wireless mobile device.

11. The computer implemented process of claim 10 wherein steps (d) and (e) comprise the step of running the inputted data through one or more equations stored within a database and creating an output file of the result and generating HTML code for the output page.
